(19) United States
(12) Patent Application Publication
(10) Pub. No.: US 2015/0217370 A1
(43) Pub. Date: Aug. 6, 2015

(54) TECHNIQUES USING LUBRICANT COMPOSITE FOR MANUFACTURE OF PARTS FROM METAL POWDER

(71) Applicant: Nanogestion Inc., Brossard (CA)

(72) Inventor: Patrick Lemieux, Ste-Julie (CA)

(21) Appl. No.: 14/421,740

(22) PCT Filed: Feb. 7, 2013
(86) PCT No.: PCT/CA2013/050097

§ 371 Date: Feb. 13, 2015

Related U.S. Application Data
(60) Provisional application No. 61/682,797, filed on Aug. 14, 2012.

(51) Int. Cl. B22F 3/02; C10M 111/04; B05D 5/00; B22F 3/00; B22F 1/00

(52) U.S. Cl. CPC B22F 3/02; B22F 3/005; B22F 1/0059; B22F 3/003; B05D 5/00; C10M 111/04; B22F 2003/026

(57) ABSTRACT

Lubricant composition and related methods and apparatus for manufacturing a green compact in a die cavity during a powder metallurgy operation wherein the lubricant composition includes a first component and a second component. The first component has a starting phase, an active phase, and a transition temperature at which at least part of the first component changes state from the starting phase to the active phase. Upon contact with wall surfaces of the die cavity, the first component transitions from the starting phase to the active phase, and the second component adheres to the active phase of the first component to form a lubrication layer coating the die wall surfaces. The component may be a first solid particulate component, such as polymeric particulate material or a sugar, or a first gaseous component, such as water vapor or palm oil vapor, respectively able to melt or condense upon contact with die cavity.

### TECHNICAL FIELD

The technical field concerns metal powder part manufacturing, and more particularly to techniques for lubrication of wall surfaces of a die cavity used in powder metallurgy.

### BACKGROUND

In the field of powder metallurgy, metal parts are typically manufactured through a series of steps. Metal powders may be mixed with powder lubricants and other additives to form a metallurgical powder mixture that is filled into a die cavity. Such lubricants may be referred to as “admixed lubricants”. The metallurgical powder mixture is then compacted within the die to produce a green compact. The green compact is then ejected from the die cavity and can undergo further processing, including sintering in order to produce a metal part.

The lubricant in the metallurgical powder mixture is supposed to sufficiently lubricate the die cavity wall surfaces to prevent permanent damage to the wall surfaces that may occur during compaction and to provide adequate surface finish on the green compact ejected from the die after compaction. However, in some cases it may be difficult or undesirable to incorporate lubricant into the powder mixture, due to various reasons that may relate to operating parameters or properties of the manufacturing operation, such as purity, reactivity, green strength, cured strength of the metal parts, and so on. In other cases, it may be desirable to decrease or minimize the amount of lubricant that is mixed with the powder metal, for various reasons such as to provide a higher maximum density that can be reached during compaction, given that the admixed lubricant occupies a certain volume between particles of the metallurgical powder mixture and limit its final density. In addition, in some case, even with the use of internal or admixed lubricant, parts can be too complex and/or too difficult to eject and/or powders can be too soft (e.g. aluminium powders), such that surface finish may be poor after ejection and die walls may suffer some damage. In such cases, the use of external lubrication has been developed, and may be generally referred to as “die wall lubrication”.

Regarding die wall lubrication, solid powdered lubricants similar to admixed lubricants that can be mixed with the metal powder can be delivered to the die cavity in different ways.

There are some die wall lubricants that are known in the field. The use of simple oils as die wall lubricants has been found to be insufficient to sustain the high shear stress that occurs at the boundary between the metal powder mixture and the die wall surfaces during compaction and ejection. In addition, mixtures of oils or other liquids with solid lubricant particles may be challenging to inject uniformly and cleanly in the die cavity. For instance, drops can fall on the die top or die platen later in the manufacturing cycle and when the metallurgical powder mixture is fed via a feed shoe or another means, the metallurgical powder may tend to stick and form a slurry accumulating on the top of the die, eventually hampering or damaging the press and feed shoe movements or disturbing the metallurgical powder mixture by sticking to one component more than another. This problem can also lead to density heterogeneity during compaction if the metallurgical powder mixture falling in the die cavity comes into contact with a liquid drop. Consequently, in view of such challenges, liquid die wall lubricants are often avoided in standard powder metallurgy practice.

Another method of lubricating die cavity wall surfaces is described in U.S. Pat. No. 5,682,591 (Inculet et al.) and includes electrostatically spraying a lubricant onto the wall surfaces of the die cavity. The lubricant can be fine liquid droplets or solid particles. The solid particle lubricant is electrostatically charged and attracted to the wall surfaces of the die cavity, for example by the grounded or even polarized walls of the die. This method of lubricating die cavity wall surfaces has met with some success for low deepness cavities and simple shapes.

For deeper cavity applications, other techniques have been developed to reduce formation of eddies that can lead to inhomogeneous coverage of the wall surfaces. U.S. Pat. No. 6,299,690 (Mongeon et al.) describes a method of lubricating the wall surfaces of a die cavity including spraying the wall surfaces with tribocharged lubricant particles via a plug member (which may also be referred to as a “confinement block”) having a shape conforming to that of the article to be formed. The plug member is slightly smaller than the article so that when the plug member is inserted into the die cavity there is a small, but uniform, gap created between the outer wall surfaces of the plug member and the walls of the die cavity. This method lead to improved uniform coverage of the die cavity wall surfaces for deeper cavities.

However, the technique described by Mongeon et al. has some challenges, for example related to ejection of long parts from deep cavities when high compaction pressures are used for mixtures with low amounts of admixed lubricant or no admixed lubricant. When the metal part—and, consequently, the green compact—is long and the die cavity is deep, the green compact is slid a long distance in order to be completely ejected from the die cavity. The technique described by Mongeon et al., using a plug member and electrostatic charging of the die wall lubricant, is effective at producing a uniform coverage on deep die cavity walls. However, electrostatic charging of lubricant particles enables providing one layer of particle lubricant on the wall surface and any subsequent layers are difficult to provide because they would not be in direct contact with the grounded or polarized die walls. Rather, such subsequent layer of lubricant particles would feel the effect of the charge of the first deposited layer of particles that carry the same charge as themselves and repulsive forces would be generated preventing a second layer of lubricant to stick to the wall surfaces of the die cavity. Consequently, this technique can provide thin layers of die wall lubricant, but as there are challenges related to providing thicker layers, it can be difficult to obtain a good surface finish and prevent die wall deterioration with deep die cavities.

### SUMMARY

The present invention provides techniques for die wall lubrication that may be used, for example, in deep die cavity applications.

In one aspect, there is provided a method for manufacturing a green compact in a powder metallurgy operation. The method includes:
providing a die cavity having die wall surfaces;
providing a lubricant composition including:
   a first component having a starting phase, an active phase, a transition temperature at which at least part of the first component changes state from the starting phase to the active phase, an active phase temperature range where the first component is in the active phase and a starting phase temperature range where the first component is in the starting phase; and wherein the first component in the active phase adheres to the die wall surfaces; and
   a second component in particulate form having a solid phase temperature range where the second component is in a solid state, wherein the second component in solid state adheres to the active phase of the first component;
maintaining the die cavity to an operating temperature falling within said active phase temperature range of the first component;
feeding the lubricant composition at a feeding temperature falling within said starting phase temperature range of the first component and said solid phase temperature range of the second component into the die cavity thereby causing at least part of the first component to change into the active phase and to form with the second component a lubrication layer coating the die wall surfaces feeding a metallurgical powder mixture into the die cavity;
compacting the metallurgical powder composition in the die cavity at a compaction pressure sufficient to form the green compact; and
ejecting the green compact from the die cavity.
In some implementations, the operating temperature may fall within the solid phase temperature range of the second component.

In some implementations, the metallurgical powder mixture may include at least about 85 wt % of a metal-based powder.

In some implementations, the lubricant composition may be provided in an amount sufficient to reduce or prevent galling, scoring or damaging the green compact or the die wall surfaces.

In some implementations, the step of feeding the lubricant composition into the die cavity may include injecting the lubricant composition via a plug member inserted into the die cavity.

In some implementations, the step of feeding the lubricant composition into the die cavity may include guiding a flow of the lubricant composition in the die cavity so as to be close to the wall surfaces. Optionally, the guiding may include inserting a bloc into the cavity to define a gap between an external surface of the bloc and the die wall surfaces.

In some implementations, the second component may have a melting temperature above the operating temperature.

In some implementations, the second component may include at least one of metal stearates based particles, ethylene bistearamide based particles, polyolefin-based fatty acids based particles, polyethylene-based fatty acids based particles, polyethylene based particles, soap based particles, molybdenum disulfide based particles, graphite based particles, manganese sulfide based particles, calcium oxide based particles, boron nitride based particles, polytetrafluoroethylene based particles, natural wax based particles and synthetic wax based particles.

In some implementations, the second component may include at least two powder compositions.

In some implementations, the second component may form a barrier between the metallurgical powder mixture and the die wall surfaces during compacting the metallurgical powder composition in the die cavity. Optionally, the second component may form a barrier between the metallurgical powder mixture and the die wall surfaces during ejecting of the green compact from the die cavity.

In some implementations, the lubricant composition may include at least one lubricant additive. Optionally, the lubricant additive may include at least one of molybdenum disulfide based particles, graphite based particles, manganese sulfide based particles, calcium oxide based particles, boron nitride based particles, polytetrafluoroethylene based particles, boron nitride based particles, and silica based particles.

In some implementations, the first component may be a first solid particulate component having a melting temperature below the operating temperature. Optionally, the first solid particulate component may be at least about 5 wt % based on a total weight of the lubricant composition.

In some implementations, the melting temperature of the first solid particulate component may be at least about 5° C. lower than the operating temperature. Optionally, the melting temperature of the first solid particulate component may be between about 5° C. and about 40° C. below the operating temperature. Further optionally, the melting temperature of the first solid particulate component may be greater than a room temperature.

In some implementations, the first solid particulate component may include a polymeric material being a synthetic polymeric material or a natural polymeric material. Optionally, the polymeric material may be at least one of a fatty acid, ethylene bistearamide based particles, glyceryl behenate based particles, glyceryl distearate based particles, polyolefin-based fatty acids based particles, polyethylene-based fatty acids based particles and soap based particles. Optionally, the first solid particulate component may include an organic material, such as a saccharine, a sugar or sugar based particles and.

In some implementations, the operating temperature may be between about 20° C. and about 300° C. Optionally, the operating temperature is between about 20° C. and about 120° C. Further optionally, the operating temperature may be between about 60° C. and about 90° C.

In some implementations, the method may further include the step of pre-mixing the first particulate solid component and the second component to produce the lubricant composition, prior to providing the lubricant composition into the die cavity.

In some implementations, the first component may be a first gaseous component having a condensation temperature higher than the operating temperature. Optionally, the first gaseous component may be at least one of water vapor and oil vapor.

In some implementations, the oil vapor may be a vapor of an oil having a boiling point at least about 40° C. below a burning point or fume point. Optionally, the oil vapor may include a vapor of vegetal sourced oil. Further optionally, the oil vapor may be a vapor of palm oil.

In some implementations, the condensation temperature of the first gaseous component may be at least about 10° C. higher than the operating temperature.

In some implementations, the operating temperature may be between about 20° C. and about 200° C. Optionally, the operating temperature may be between about 20° C. and about 150° C.

In some implementations, the step of providing the lubricant composition into the die cavity may include:
providing one of the first solid particulate component or second component into the die cavity; and
providing the other of the first solid particulate component or second component into the die cavity.

In some implementations, the step of providing the lubricant composition into the die cavity may include providing simultaneously the first component and the second component into the die cavity.

In some implementations, the method may include increasing gas flow perturbation in a gap defined between a plug member and the die wall surfaces. Optionally, the increasing of the gas flow perturbation may include providing at least one of ribs, dimples and other irregularities on an external surface of the plug member such that a mixture of lubricant composition and gas injected into the gap is subjected to the increased gas flow perturbation. Optionally, the increasing of the gas flow perturbation may be sufficient to increase collisions of the lubricant composition against the wall surfaces of the die cavity. Optionally, the increased collisions may result in an increased thickness or an increased die coverage density of a lubricant layer on the die wall surfaces.

In another aspect, there is provided a method for lubricating a die cavity for a powder metallurgy operation, including:
providing a lubricant composition into the die cavity, the lubricant composition including:
   a first component having a starting phase, an active phase, a transition temperature at which at least part of the first component changes state from the starting phase to the active phase, an active phase temperature range where the first component is in the active phase and a starting phase temperature range where the first component is in the starting phase; and wherein the first component in the active phase adheres to the die wall surfaces; and
   a second component in particulate form having a solid phase temperature range where the second component is in a solid state, wherein the second component in solid state adheres to the active phase of the first component;
maintaining the die cavity to an operating temperature falling within said active phase temperature range of the first component;
feeding the lubricant composition at a feeding temperature falling within said starting phase temperature range of the first component and said solid phase temperature range of the second component into the die cavity thereby causing at least part of the first component to change into the active phase and to form with the second component a lubrication layer coating the die wall surfaces.

In some implementations, the operating temperature may fall within the solid phase temperature range of the second component.

In another aspect, there is provided a method for manufacturing a green compact in a powder metallurgy operation, including:
heating a die cavity having die wall surfaces to an operating temperature;
providing a solid particulate lubricant composition into the die cavity, the solid particulate lubricant composition including:
   a first particulate component having a melting temperature lower than the operating temperature of the die such that at least part of the first particulate component melts in contact with the die wall surfaces to form a melted component; and
   a second particulate component having a sufficiently high melting temperature to remain in solid state at the operating temperature, thereby allowing at least part of the second particulate component to adhere to the melted component;
   wherein the melted component and the second particulate component form a lubrication layer coating the die wall surfaces;
feeding a metallurgical powder mixture into the die cavity;
compacting the metallurgical powder composition in the die cavity at a compaction pressure sufficient to form the green compact; and
ejecting the green compact from the die cavity.

In some implementations, the method may further includes charging the solid particulate lubricant composition, prior to providing the solid particulate lubricant composition into the die cavity, such that the solid particulate lubricant composition is electrostatically attracted to the die wall surfaces. Optionally, the method may further include triboelectrically charging the solid particulate lubricant composition, prior to providing the solid particulate lubricant composition into the die cavity, such that the solid particulate lubricant composition is electrostatically attracted to the wall surfaces of the die cavity.

In another aspect, there is provided a method for manufacturing a green compact in a powder metallurgy operation, including:
maintaining a die cavity having die wall surfaces to an operating temperature;
providing a lubricant composition into the die cavity, the lubricant composition including:
   a first gaseous component having a condensation temperature higher than said operating temperature of the die such that at least part of the first gaseous component condensate in contact with the die wall surfaces to form a liquid component; and
   a second particulate component having a sufficiently high melting temperature to remain in solid state at the operating temperature, thereby allowing at least part of the second particulate component to adhere to the liquid component;
   wherein the liquid component and the second particulate component form a lubrication layer coating the die wall surfaces;
feeding a metallurgical powder mixture into the die cavity;
compacting the metallurgical powder composition in the die cavity at a compaction pressure sufficient to form the green compact; and
ejecting the green compact from the die cavity.

In another aspect, there is provided a method for lubricating a die cavity for a powder metallurgy operation, including:
heating the die cavity having die wall surfaces to an operating temperature;
providing a solid particulate lubricant composition into the die cavity, the solid particulate lubricant composition including:
   a first particulate component having a melting temperature lower than said operating temperature of the die cavity such that at least part of the first particulate component melts in contact with the die wall surfaces to form a melted component;
   a second particulate component having a sufficiently high melting temperature to remain in solid state at said operating temperature, thereby allowing at least part of the second particulate component to adhere to the melted component;
      wherein the melted component and the second particulate component form a lubrication layer coating the die wall surfaces.

In another aspect, there is provided a method for lubricating a die cavity for a powder metallurgy operation, including:
maintaining the die cavity having die wall surfaces to an operating temperature;
providing a lubricant composition into the die cavity, the lubricant composition including:
   a first gaseous component having a condensation temperature higher than said operating temperature of the die such that at least part of the first gaseous component condensate in contact with the die wall surfaces to form a liquid component; and
   a second particulate component having a sufficiently high melting temperature to remain in solid state at the operating temperature, thereby allowing at least part of the second particulate component to adhere to the liquid component;
      wherein the liquid component and the second particulate component form a lubrication layer coating the die wall surfaces.

In another aspect, there is provided a lubricant composition for lubricating die wall surfaces of a die cavity, the lubricant composition including:
a first component in a starting phase, the first component having:
   an active phase wherein the first component is adapted to adhere to the die wall surfaces;
   said starting phase; and
   an active phase temperature range adapted for transition of the first component from the starting phase to an active phase in contact with the die wall surfaces;
a second component in solid state and having a solid state temperature range allowing the second component to adhere to the active phase of the first component.

In some implementations, the first component may be a first solid particulate component having a melting temperature adapted for transition from the starting phase to the active phase in contact with the wall surfaces. Optionally, the first solid particulate component may be at least about 5 wt % based on a total weight of the lubricant composition.

In some implementations, the first solid particulate component may include a polymeric material being a synthetic polymeric material or a natural polymeric material. Optionally, the polymeric material may be at least one of a fatty acid, ethylene bistearamide based particles, polyolefin-based fatty acids based particles, polyethylene-based fatty acids based particles, sugar based particles and soap based particles.

In some implementations, the first component may be a first gaseous component having a condensation temperature adapted for transition from the starting phase to the active phase in contact with the wall surfaces. Optionally, the first gaseous component may be at least one of water vapor or oil vapor. Optionally, the oil vapor may be a vapor of an oil having a boiling point at least about 40° C. below a fume point or burning point. Optionally, the oil vapor may include a vapor of vegetal sourced oil. Optionally, the oil vapor may be a vapor of palm oil.

In another aspect, there is provided a solid particulate lubricant composition for lubricating wall surfaces of a die cavity, the solid particulate lubricant composition including:
a first component having a melting temperature which is adapted to form a melted component in contact with the wall surfaces through melting of at least part of the first particulate component; and
a second particulate component having a melting temperature allowing the second particulate component to remain in solid state in contact with the wall surfaces and thereby allowing at least part of the second particulate component to adhere to the melted component.

In another aspect, there is provided an apparatus for lubricating die wall surfaces for a powder metallurgy operation, including:
a lubricant delivery system for delivering a lubricant composition;
a die including:
   a die cavity defined by wall surfaces;
   an inlet in fluid communication with the lubricant delivery system for receiving the lubricant composition into the die cavity for deposition onto the wall surfaces; and
a temperature management system coupled to the lubricant delivery system and the die for controlling at least one of an operating temperature of the lubricant delivery system and an operating temperature of the die.

In some implementations, the temperature management system may be configured for controlling the operating temperature of the lubricant delivery system below the operating temperature of the die.

In some implementations, the temperature management system may be configured for controlling the operating temperature of the lubricant delivery system above the operating temperature of the die.

In some implementations, the apparatus may include a charging system coupled to the solid lubricant delivery system for electrically charging the solid particulate lubricant composition. Optionally, the charging system may be a triboelectrical charging system.

It should be understood that any one of the above mentioned optional aspects of each method, lubricant composition and apparatus may be combined with any other of the aspects thereof, unless two aspects clearly cannot be combined due to their mutually exclusivity. For example, the various operational steps of the methods described herein-above, herein-below and/or in the appended figures, may be combined with any aspects of the method, composition and apparatus descriptions appearing herein and/or in accordance with the appended claims.

### BRIEF DESCRIPTION OF DRAWINGS

FIG. 1 is a process flowchart according to an optional aspect of the present invention.

FIG. 2 is a schematic cut view showing a lubrication application for a die cavity according to an optional aspect of the present invention.

FIG. 3 is a schematic cut view showing another lubrication application for a die cavity according to an optional aspect of the present invention.

FIG. 4 is a photograph of a surface finish of an ATOMET product containing pure iron particles and no internal admixed lubricants, pressed in the form of a cylinder pressed with a specially developed lubricant for a mix of powders containing no admixed lubricant.

FIG. 5 is a schematic drawing of two types of tubular confining blocks according to an optional aspect of the present invention.

FIG. 6 is a graph of a ATOMET product containing pure iron particles and no internal admixed lubricant, giving the compressibility curves for different lubricant compositions according to an optional aspect of the present invention.

FIG. 7 is a graph of a ATOMET product containing pure iron particles and no internal admixed lubricant, giving ejection curves for different lubricant compositions according to an optional aspect of the present invention.

FIG. 8 is a graph of a ATOMET product containing pure iron particles and no internal admixed lubricant, giving ejection curves for three different compaction pressures with ZnSt spray lubricant.

FIG. 9 is a graph of a ATOMET product containing pure iron particles and no internal admixed lubricant, giving ejection curves for three different compaction pressures with Lube 1 die wall lubricant composition according to an optional aspect of the present invention.

FIG. 10 is a graph of a ATOMET product containing pure iron particles and no internal admixed lubricant, giving ejection curves for three different compaction pressures with Lube 2 die wall lubricant composition according to an optional aspect of the present invention.

FIG. 11 is a graph of a ATOMET product containing pure iron particles and no internal admixed lubricant, giving ejection curves for cylinders pressed to 7.18 g/cc with three different die wall lubricant compositions according to an optional aspect of the present invention.

FIG. 12 is a photograph of a surface finish of two cylinders pressed with a ATOMET product containing pure iron particles and no internal admixed lubricant, and with respectively with Lube 2 and MoS2 added die wall lubricant composition.

FIG. 13 is a photograph of a die cavity after a step of a lubrication method according to an optional aspect of the present invention.

FIG. 14 is another photograph of the die cavity of FIG. 13 after another step of the lubrication method according to an optional aspect of the present invention.

FIG. 15 is a graph of a ATOMET product containing pure iron particles and no internal admixed lubricant, giving ejection curves for various die wall lubricant compositions including lubricant compositions according to an optional aspect of the present invention.

While the invention will be described in conjunction with example embodiments, it will be understood that it is not intended to limit the scope of the invention to such embodiments. On the contrary, it is intended to cover all alternatives, modifications and equivalents as may be included as defined by the present description and the appended claims. The objects, advantages and other features of the present invention will become more apparent and be better understood upon reading of the following non-restrictive description of the invention, given with reference to the accompanying drawings.

### DETAILED DESCRIPTION

In some implementations, techniques for lubricating a die wall surface for a powder metallurgical operation utilize at least two lubricant components having different temperature response properties in order to enhance lubrication performance.

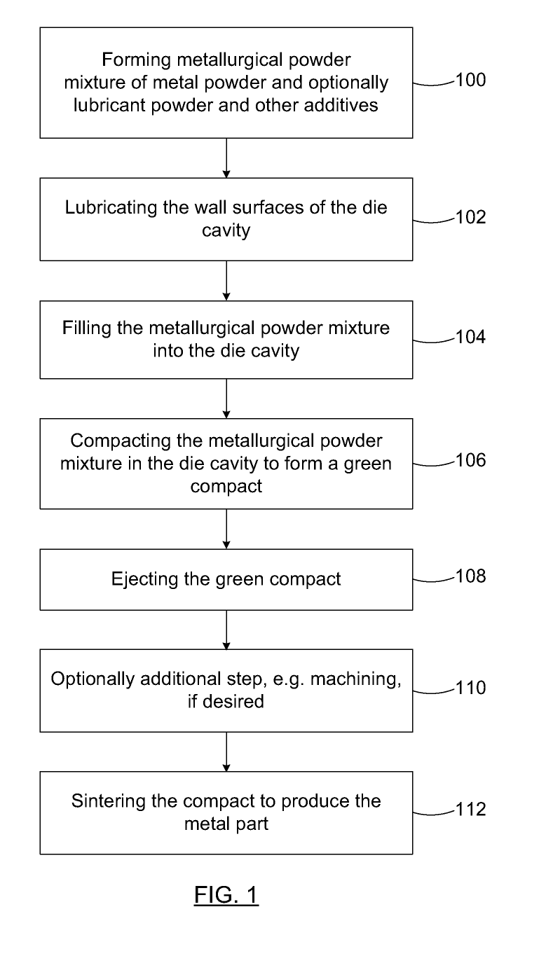

Referring to FIG. 1, an optional implementation of a process for manufacturing metal parts from metal powders is illustrated. The overall process may include forming a metallurgical powder mixture including metal powder and optionally lubricant powder and other additives (step 100); lubricating the wall surfaces of the die cavity (step 102) with a lubricant composition; filling the metallurgical powder mixture into the die cavity (step 106); compacting the metallurgical powder mixture in the die cavity to form a green compact (step 108); ejecting the green compact from the die (step 108); optionally subjecting the compact to an additional treatment (step 110) which generally depends on the composition of the metallurgical powder mixture and is intended to be able to do a second deformation operation or machining operation; and sintering the compact to produce the metal part (step 112). Of course, it should be understood that there may be various alternative or optional steps that may be used for manufacturing metal parts from metallurgical powders.

In some implementations, the lubricant composition includes a first component and a second component. The first component has temperature response properties such that it can be delivered to the die cavity in a starting phase and, once in contact with the die wall surfaces, at least part of the first component undergoes a temperature induced transition from the starting phase to an active phase. The active phase of the first component adheres to the wall surfaces as an adhesive lubricating component. The second component is a solid particulate second component which has properties such that it remains in solid state while delivered to the die cavity, allowing at least part of the second particulate component to adhere to the active phase of the first component to form a lubricating layer on the wall surfaces. The second component may also remain in solid state within the die cavity to form a solid lubricating barrier on the active phase.

More particularly, upon contact with the wall surfaces, the first component becomes sticky enough to adhere to the wall surface and then can retain additional lubricant composition including the first and second components as well as additional lubricant particles that may be provided in the lubricant composition. It is then possible to increase the thickness of the lubricating layer deposited, as subsequently deposited first and/or second components stick to the previously adhered layer that includes the active phase of the first component that is formed on the wall surfaces of the die cavity.

In some implementations, the first component may be a first particular component having temperature response properties such that it can be delivered to the die cavity in solid powder state and, once in contact with the die wall surfaces, at least part of the first particulate component undergoes a temperature induced transition increasing its adhesiveness so as to adhere to the wall surfaces as an adhesive lubricating component. The first particulate component may include a solid powder (starting phase) which melts upon contact with the die wall surfaces maintained at an operating temperature superior to the melting point of the solid powder, thereby enabling a temperature induced transition and form a melted liquid layer (active phase) on the die wall surfaces.

Alternatively, in some implementations, the first component may be a first gaseous component having temperature response properties such that it can be delivered to the die cavity in a gaseous state and, once in contact with the die wall surfaces, at least part of the first gaseous component undergoes a temperature induced transition increasing its adhesiveness so as to adhere to the wall surfaces as an adhesive lubricating component. The first component may include a gas (starting phase) which condense upon contact with the die wall surfaces maintained at an operating temperature inferior to the condensation point of the gas, thereby enabling a temperature induced transition and form a condensed liquid layer (active phase) on the die wall surfaces.

It should be understood that the temperature induced transition is not limited to melting or condensation and may relate to other transition temperatures such as for example glass-liquid transition temperature.

### Implementations of the Lubricant Delivery Systems for the Die

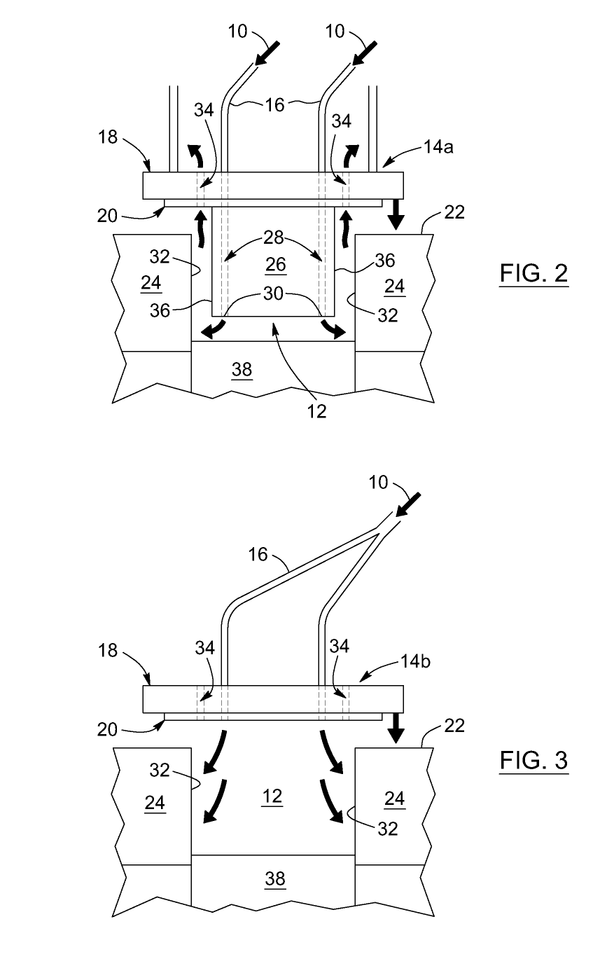

Referring now to FIGS. 2 and 3, the lubricant composition 10 may be provided to the die cavity 12 using various different delivery systems 14a, 14b, two of which are illustrated. It should be understood that many different variations and other types of delivery systems may be used.

Referring to FIG. 2, the delivery system 14a may include delivery tubes 16 that transport the lubricant composition 10 from a mixing or holding container (not illustrated). The lubricant composition 10 may be transported aided by a carrier gas. When using a lubricant composition including solid particulate components, the tubes and the carrier gas may be chosen to facilitate electrostatic charging of the solid particles during transport. A tribo-charging gun or a corona charging gun can also be inserted in the circuit to enhance charging of the lubricant particles. The delivery system 14a may include a plate member 18 with a sealing member 20. The plate member 18 is configured to move downward such that the sealing member 20 contacts and creates an adequate seal with an upper surface 22 of the die 24. The delivery system 14a may also have a plug member 26 extending downwardly from the plate member 18 so as to be insertable into the die cavity 12. The plug member 26 may have a shape that substantially conforms to the shape of the part to be produced in the die cavity 12. The plate member 18 and the plug member 26 have conduits 28 extending there-through and which are in fluid communication with the tubes 16 for receiving the lubricant composition 10 and releasing it through outlets 30 located and configured around the plug member 26 depending of various factors such as the shape of the die cavity 12. There is a gap in between the outer surface of the plug member 26 and the wall surfaces 32 of the die cavity allowing the lubricant composition 10 to travel and coat the wall surfaces 32. Excess lubricant composition 10 is allowed to exit via outlet channels 34 in fluid communication with the gap. The outlet channels 34 may be provided in the plate member 18 and/or other locations. The delivery method illustrated in FIG. 2 may be referred to generally as the “plug method”. The delivery system and other elements of the device may be as described in U.S. Pat. No. 6,299,690.

In some implementations, the plug member 26 may be provided with an outer surface 36 that includes irregularities in order to increase the perturbations in the gap and increase the number of collision of the lubricant particles with the wall surfaces 32 of the die cavity 12. Such irregularities may take the form of ribs and/or dimples, having various shapes such as hexagonal or another shape sufficient for causing more impact of the particles with the die walls at the given flow conditions (example seen on FIG. 5).

Referring now to FIG. 3, the delivery system 14b may include delivery conduits in the plate member 18 for injecting the lubricant composition 10 without a plug member. In the scenario of solid particulate first and second components, it is preferred that the lubricant composition 10 is electrostatically charged sufficiently to be attracted and to form a layer on the wall surfaces 32 of the die cavity 12. Some outlet channels 34 in fluid communication with the cavity are also provided at some locations in the plate member.

Referring to FIGS. 2 and 3, a lower punch member 38 is provided and can be actuated for compaction of the metallurgical powder mixture and ejection of the green compact from the die cavity 12.

In some implementations, the first solid particulate component and/or the second solid particulate component may be electrostatically charged prior to being provided into the die cavity 12. Charging may aid in the initial attraction of the lubricant composition 10 toward the wall surfaces and upon contact with the wall surfaces the temperature induced adhesive transition of the first solid particulate component may replace electrostatic force as the dominant force retaining the lubricant against the wall surfaces.

In alternative implementations, other methods may be used to aid the initial attraction of the lubricant composition 10 toward the wall surfaces. For example, increasing gas flow perturbations in the gap between the plug member and the wall surfaces can increase the number of collisions of the lubricant composition against the wall surfaces. Such flow perturbations may be increased by providing a designed flow entering the die cavity and/or providing surface irregularities on the outer surface of the plug member, for example. It has been found that surface irregularities on the plug member can reduce the ejection force required to eject the green compact by about 10%.

### Implementations of the Die Operation and Temperature

In some implementations, the wall surfaces of the die are operated at a surface temperature Tₛ that is coordinated with a transition temperature T₁ of the first component. In some scenarios, |T₁−Tₛ| is such that the first component, upon contact with the wall surfaces, undergoes a temperature induced transition increasing its adhesiveness so as to adhere to the wall surfaces. For example, |T₁−Tₛ| may be at least equal to 5° C. |T₁−Tₛ| may be at least equal to 10° C., 15° C., 20° C., 25° C., 30° C., 35° C., 40° C., 45° C., 50° C., 55° C. or 60° C. The temperature difference between Tₛ and T₁ may depend on various factors, such as the composition of the first component, the material of the die wall surfaces, the delivery method which may include electrostatic or flow perturbation enhanced attraction of the first particulate component toward the wall surfaces as well as other operating parameters.

In some implementations, when the first component is for example a solid particulate first component, the transition temperature T₁ may be the melting temperature Tₘ₁. Tₘ₁ may be sufficiently lower than Tₛ to induce transition from the solid phase (starting phase) to the active phase upon contact with the die wall surfaces and form a melted layer thereon. For example, Tₘ₁ may be at least 5° C. lower than Tₛ. Tₘ₁ may be not so much lower than Tₛ such that the resulting adhesive lubricating layer that is formed on the wall surfaces reaches a temperature sufficient to reduce its viscosity and cause it to flow in the interval of time prior to compaction such that would reduce the overall lubrication effectiveness. If the temperature difference is excessive, the benefits of the first solid particulate component in the lubricant composition 10 may be reduced. In some scenarios, Tₘ₁ may be lower than Tₛ by about 5° C. to about 40° C. In particular, Tₘ₁ may be lower than Tₛ by about 25° C. to about 35° C. For example, it was found that a scenario where Tₘ₁=57° C. and Tₛ=85° C. provided excellent results.

In some implementations, when the first component is for example a gaseous particulate first component, the transition temperature T₁ may be the condensation temperature T_{d}. T_{c1} may be sufficiently higher than Tₛ to induce transition from the gaseous phase (starting phase) to the active phase upon contact with the die wall surfaces and form a condensed layer thereon. For example, T_{c1} may be at least 10° C. higher than Tₛ. In some scenarios, T_{c1} may be higher than Tₛ by about 10° C. to about 150° C. For example, it was found that a scenario where T_{c1}=80° C. and Tₛ=20° C. provided excellent results.

In some implementations, the powder metallurgical operation may include external heating of the die cavity or even “warm pressing”, where the die and the metallurgical powder mixture is heated above the natural friction equilibrium temperature. The die may be heated such that Tₛ=85° C., 100° C. or 110° C., for example. During the “warm pressing” operations, the die can even be heated up to an operating temperature of 120° C., 150° C., 175° C., 200° C., 250° C., 300° C., or even 350° C.

It should be noted that, in some optional implementations, the temperature of the die may also be coordinated with temperature responsive properties of the first particulate component other than the melting temperature and condensation temperature. For example, for materials that may have certain transition temperatures, e.g. a glass transition temperature T_{g1} and/or softening temperature. The operating temperature of the die may be provided adequately with respect to the given transition temperature such that contact with the first component induces the transition increasing the adhesiveness of the first component so as to adhere to the wall surfaces as the adhesive lubricating component.

In addition, since the first component and second component of the lubricant composition 10 should stay substantially in respective starting phase and solid state, in the delivery system (e.g. to avoid fouling issues), the delivery system temperature T_{d} may be coordinated with Tₛ as well as T₁. For example, in case the first component is a first solid particulate component and in certain situations in which T_{d} is relatively high (e.g. in hot climate countries, hot seasons or hot manufacturing environments), Tₛ may be provided at a higher temperature and the temperature response properties of the first component may be chosen accordingly. For example, if the delivery system T_{d}=40° C., Tₘ₁ may be about 60° C. and Tₛ may be about 85° C. If the delivery system is a cooler T_{d}=20° C., Tₘ₁ and Tₛ may be adjusted, for example at about 45° C. and 65° C. respectively. The delivery system may be cooled in some optional implementations, for example to ensure that the first solid particulate component is solid during delivery. Alternatively, in case the first component is a gaseous component, the die cavity may be cooled and the delivery system may be heated such that the first component remains gaseous during delivery and condense efficiently upon contact with the wall surfaces of the die.

Temperature management in general may be performed and the first component as well as Tₛ may be chosen for desired operating parameters to provide efficient operation. There may be a temperature management system included in the overall apparatus to manage the temperatures of the different parts of the apparatus according to the properties of the first and second components.

### Implementations of the Lubricant Composition

The lubricant composition 10 has at least the first and second components. It should be understood that there may be three or more components in the lubricant composition 10, which have lubricating properties.

In some implementations, the first solid particulate component may include or consist essentially of a polymeric or organic material being a synthetic polymeric material or an organic polymeric material. The polymeric material may be at least one of a fatty acid, wax based particles (e.g. ACRAWAX™), ethylene bistearamide based particles, glyceryl behenate based particles, glyceryl distearate based particles, polyolefin-based fatty acids based particles, polyethylene-based fatty acids based particles, sugar based particles and soap based particles, having the appropriate temperature response properties, e.g. melting temperature, for the given temperature and operating conditions of the die. Optionally, fumed silica and graphite may be mixed with the first solid particulate component for enhancing fluidity of the latter and enabling to obtain a thin layer of melted first particulate component on the die walls.

In some implementations, the first gaseous component may include or consist essentially of water vapor or oil vapor. The oil vapor may be a vapor of an oil having a boiling point at least about 40° C. below a burning point or fume point. Optionally, the oil vapor may be a vapor of vegetal sourced oil, such as palm oil. In some implementations, the second component may be chosen from one that is known to be a good lubricant for high or very high shearing stresses. The second particulate component may include metal stearates based particles, ethylene bistearamide based particles, polyolefin-based fatty acids based particles, polyethylene-based fatty acids based particles, polyethylene-based based particles, soap based particles, molybdenum disulfide based particles, graphite based particles, manganese sulfide based particles, calcium oxide based particles, boron nitride based particles, polytetrafluoroethylene based particles, or natural or synthetic wax based particles, or a combination thereof.

In some experiments, lubrication was attempted using a composition including only a first solid particulate component, having a melting temperature of about 55° C. Used alone, the ejection force was elevated, and the green compact and cavity surface suffered some galling, which is when some material from the metallurgical powder mixture stays stuck to the cavity wall and so the green compact surface includes scratches. This lubricant component used alone did not perform well at operating conditions where it melted upon contact with the wall surfaces, despite that this same lubricant can perform well for easy parts and moderate compacting pressure and density at operating conditions where it stays solid at a lower die wall temperature. In general, lubricants in liquid form have drawbacks in terms of resisting to the very high shearing stress developed during the compaction and ejection of steel powder part.

However, when a second particulate lubricant component was added to the composition, the second component particles that remain solid stick to the adhesive lubricating component formed by the first particulate component, and the solid second component particles smear under the high shearing stress and cover the walls and can sustain the high shearing stress. The presence of the adhesive lubricating component formed by the melting or transitioning of one of the components of the solid lubricant powder composition enabled providing a thicker layer than what is possible by using only electrostatic charges to attract and keep in place a layer of solid particulate lubricant.

In addition, when using only electrostatic attraction to maintain solid lubricants against the wall surfaces of the die cavity, the force may not always be sufficient in certain applications. For example, during filling of the metallurgical powder mixture, it can scrape off part of the lubricant from the wall surfaces. This scrapping effect can be important depending on the shape and size of the cavity and the speed of the metallurgical powder mixture feeding system (feed shoe). The adhesive effect facilitated by the temperature response of the first particulate component and the adhesion of the second particulate component to the adhesive layer enables a stronger attraction of the lubricant composition with respect to the wall surfaces and is sufficient to maintain a thicker layer of lubricant in contact with the die cavity walls.

### Additional Applications, Advantages and Implementations

The techniques described herein may be used in the field of powder metallurgy to produce green compact for metal parts that have a high aspect ratio and/or complex geometries. Metal parts having elongated portions may benefit from the enhanced layer of lubrication. For example, some implementations of the techniques described herein may provide advantages for elongate parts with an aspect ratio M/Q (ejection sliding surface on pressing surface) over 5. In addition to give higher average density parts, the decreased level of friction at the die wall during compaction gives decreased density gradient in the parts. In addition, some implementations of the techniques described herein may be used for various types of metal parts, such as valve guides, spark ignition induction coils, helical gears, motor bearing caps, and so on. Some implementations of the techniques described herein of may also be useful in replacing other double densification methods such as Double-Pressing-Double-Sintering (DPDS) or Powder Forging.

In some implementations, the techniques and lubricant composition described herein are used to produce a green compact from a metallurgical powder mixture. It should be noted that some implementations of the techniques and lubricant composition may also be used in compaction molding applications other than powder metallurgy, such as compacted pharmaceutical products or other industries.

In some implementations, the layer of lubricant that is applied to the die wall surfaces is relatively thicker than conventional electrostatic methods, which is advantageous particularly for parts that are difficult to eject due to friction along long surfaces.

In some implementations, the lubricant composition may be used to coat the wall surfaces of the die cavity generally uniformly, and the coating may be a relatively thick layer of lubricant. The lubrication can enable ejection of the green compact with a substantially perfect surface finish (substantially no galling or scoring). The improved lubrication may be used for elongated parts and also for other types of parts that may benefit from a thicker die wall lubrication layer. The lubrication techniques may, for example, help to reduce or eliminate admixed lubricant that is mixed with the metallurgical powder mixture, allowing higher density parts to be manufactured.

In some implementations, the techniques provide a method of lubricating a die cavity for metal powder part manufacturing using a relatively thick layer of lubricant for parts difficult to eject. Facilitating lubricant coverage, thickness increase and buildup on the wall surfaces facilitates compaction and ejection of very long parts at very high density with no or a very low amounts of admixed lubricants in the metallurgical powder mixture.

In some implementations, it is also desired to keep the amount of die wall lubricant as low as possible to avoid removing the lubricant layer from the die when the metallurgical powder mixture is fed in the die cavity. The rubbing or scraping effect of the metallurgical powder mixture prevent the use of electrostatic charging only, particularly for high aspect ratio parts, with long die filling.

### EXAMPLES & EXPERIMENTATION

### Example 1

In one experiment, unsuccessful attempts were made to compact and eject a part at a thickness superior to 1.5 cm, at a density above 7.0 g/cc, from a metallurgical powder composition containing no internal or admixed lubricant without notable deterioration of the surface finish of the part and the die walls (galling or scoring the die walls with a die at room temperature by using solid particle lubricant in the following list of materials applied on the die wall in a dry form with the help of electrostatic charging and a plug member to deposit the lubricant as explained in U.S. Pat. No. 6,299,690; the list of materials: metal stearates based particles, ethylene bistearamide based particles, polyolefin-based fatty acids based particles, polyethylene-based fatty acids based particles, polyethylene based particles, soap based particles, molybdenum disulfide based particles, graphite based particles, manganese sulfide based particles, calcium oxide based particles, boron nitride based particles, polytetrafluoroethylene based particles, or natural or synthetic wax based particles.

### Example 2 (According to the Present Invention)

In another example, various comparative experiments were conducted in order to test the performance of combining the first and second particulate lubricant components.

A solid die wall lubricant powder was prepared by incorporating a powder having a melting point around 55° C. into a solid lubrication powder system. The die wall lubricant powder was electrostatically charged by rubbing against polytetrafluoroethylene (PTFE, Tephlon™) walls and tubes when propelled by dry argon gas at a pressure of 20 psi above atmospheric pressure and delivered into a die cavity. Delivery into the die cavity was done very close to the walls of the cavity with the help of a plug member introduced in the cavity as described herein and in U.S. Pat. No. 6,299,690. The lubricant particles were delivered into the cavity by hoses exiting the plug members through its bottom. The lubricant particulate flow first contacted the lower punch and then the wall surfaces of the cavity and then excess lubricant exited the cavity. A portion of the particulate lubricant melted as the die temperature was maintained at 85° C. After removing the plug member, a certain amount of melted transparent lubricant was observed and could be physically collected if desired. The material collected by wiping the walls of the die cavity, upon decreasing in temperature, turned white, as it was before melting. The formed layer on the wall of the cavity was thus substantially transparent and close to invisible.

The same procedure as described above was performed with the same lubricant powder (having a melting point around 55° C.) but mixed with another solid lubricant with a higher melting point above 130° C., constituting examples of the first and second particulate components. The proportion was 50 wt % of each component. In another test, this same lubricant composition was also modified by adding a certain amount of MoS₂ fine particles. The die temperature was maintained at 85° C. (about 30° C.±5° C. above the melting temperature of the first component and 45° C. below the melting temperature of the second component).

Finally, the same procedure as described above was performed, but with the second particulate solid lubricant only. The die temperature was maintained at 85° C.

The following table reports the peak ejection force (the initial static peak when the part starts to move during its ejection) and the maximum sliding ejection force (excluding the initial static peak when the part starts to move during its ejection) for the different comparative experiments. The part was a cylinder 1 cm diameter, and 1.8 cm tall. The pressure applied was adjusted to reach a density of 7.20 g/cc when the lubrication conditions were sufficient to eject the part with a good surface finish. It required approximately 38.66 tsi (533 MPa). On each of the tests, the pressure was set to 30 tsi (413 MPa) for the first sample. If surface finish and ejection force was not too high, pressure was increased until reaching a density of 7.20 g/cc. The bottom punch did not move and was fixed during compacting, only the upper punch moved during compaction. As a result, the sliding distance was much longer than the part thickness because it was a single action movement. The sliding distance (total lower punch movement to completely eject the part) was around 3.6 cm. This is a highly demanding lubrication condition. There was no internal lubricant mixed with the metallurgical powder. The metallurgical powder was pure iron particles water atomised with an average particle size approximately at 50 microns and an organic insulating coating (resin). Its commercial name is ATOMET™ from Quebec Metal Powders Inc, a division of Rio Tinto. In the following table of data, the temperature of the die (Tₛ) was maintained at 85° C. for all reported experiments.

TABLE 1
Results

| | | | Sliding | |
|---|---|---|---|---|
| | | Peak | maximum | |
| Die wall | Compacting | ejection | ejection | |
| lubricant | pressure | Force | force | |
| applied | (MPa) | (lbs) | (lbs) | Comments |
| 55° C. melting | 413 | 1866 | 1400 | Stick and slip |
| point particle | | | | noise, galling, |
| lubricant | | | | bad finish |
| 55° C. and | 533 | 600 | 800 | Perfect finish |
| 135° C. melting | | | | |
| point particle | | | | |
| Lubricant | | | | |
| mixture | | | | |
| 55° C. and | 533 | 445 | 630 | Perfect finish |
| 135° C. melting | | | | |
| point particle | | | | |
| Lubricant plus | | | | |
| MoS2 particles | | | | |
| 135° C. melting | 413 | 3300 | 2500 | Stick and slip |
| point particle | | | | noise, severe |
| lubricant | | | | galling, bad |
| | | | | finish |

It will be noted that the two examples using a first particulate component (55° C. melting point) in combination with a second particulate component (135° C. melting point), with a die cavity temperature of about 85° C., enabled a reduction in peak ejection force and a reduction in sliding maximum ejection force in addition to good surface finish of the ejected part.

It was also found that when Tₛ−Tₘ₁=about 5° C. the performance was not enhanced compared to the condition where Tₛ−Tₘ₁<0, but when Tₛ−Tₘ₁=about 30° C. the performance was significantly enhanced.

In another scenario, the first component may be ACRAWAX™ having a melting temperature of about 145° C. and the second component may be polytetrafluoroethylene based particles having a melting temperature above 300° C. The die may be heated to about 170° C. (which is 25° C. above the melting temperature of the first component but well below the melting temperature of the second component).

Following Examples 3 to 6 illustrate experiments performed with the IMFINE automatic die wall lubrication (DWL) system coupled with a coating head comprising a confining block as described in the U.S. Pat. No. 6,299,690.

A simple cylindrical shape was pressed using a tool steel die and a Tensile machine which records the compaction and ejection forces. The length of the cylinders was determined in order to approach the level of difficulty of a specific part having a shape factor M/Q where M is the friction surface and Q the compaction surface. An example of the calculation is given in Table 2 for two cylinders of a different length and two segments of a different compaction surface.

TABLE 2
Example of calculation of the M/Q ratio
for two cylinders of a different length.

| | | | M | Q | |
|---|---|---|---|---|---|
| | Peri- | | (Friction surface) | (Compaction | |
| | meter | Height | (Perimeter * height) | surface) | |
| Sample | cm | cm | cm² | cm² | M/Q |
| Imfine | 3.1 | 1.7 | 5.3 | 0.8 | 6.8 |
| cylinder | 3.1 | 1.8 | 5.7 | 0.8 | 7.2 |
| 1 cm dia | | | | | |

Three types of metallurgical powders were used:
ATOMET 1001 HP™ with an insulating resin (ferromagnetic composite powder), (Apparent density (AD) at 3.02 g/cm³ and flow at 26 s/50 g);
ATOMET 1001 HP™ with an insulating resin with 0.1% (per weight) of an internal lubricant (AD at 3.15 g/cm³ and flow at 24 s/50 g);
FC0208 mix containing 1.25% ACRAWAX™ for cleaning purposes (2% Copper and 0.8% graphite, ATOMET 1001 HP™ based powders).

The compaction and ejection curves were generated for all specimens pressed.

### Example 3

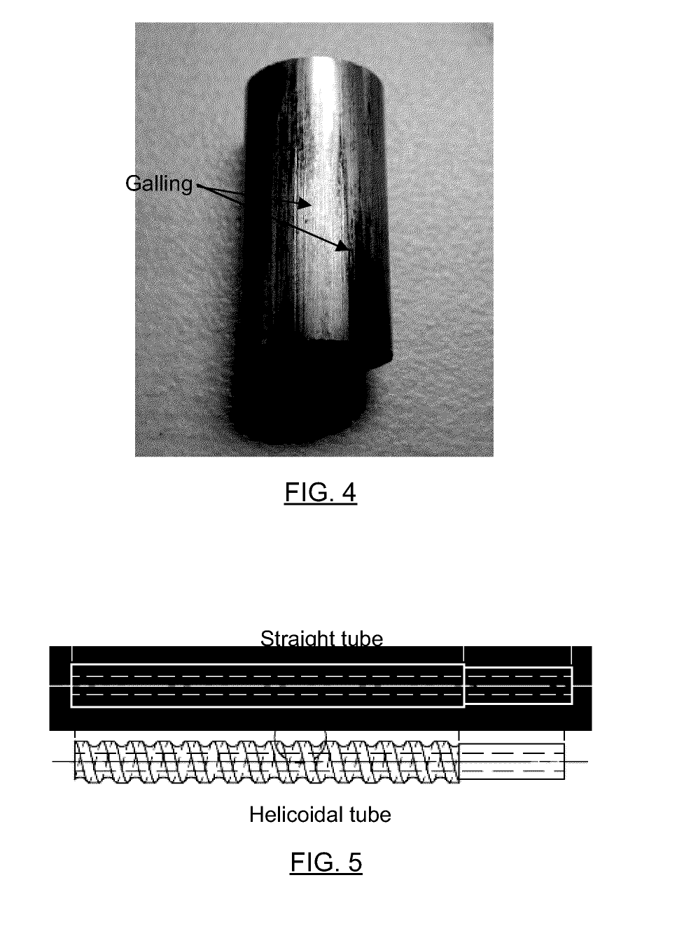

The DWL system was used with a composite lubricant developed to optimize the tribo-charging effect. This composite lubricant was specifically developed for the compaction of an ATOMET product containing pure iron particles, an insulating resin and no internal admixed lubricant, metallurgical powder. This composite lubricant includes ACRAWAX™ C atomized with 30% of a Polyethylene powders and 10% of a glycerol mono-stearate, used as a binder. The temperature of the die was 65° C. After compaction of the metallurgical powder, the ejection of the green compact was very difficult. At 30 tsi, a scratched surface finish, also referred to a galling effect, was obtained as illustrated in FIG. 4. This composite lubricant was therefore found not suitable for the compaction of this metallurgical powder mixture in the shape of long cylinders.

### Example 4 (According to the Present Invention)

### Solid Particulate Lubricant Compositions

To avoid galling, various solid particulate lubricant compositions were produced with the objective of forming adherent and thicker coatings on the die walls. The solid particulate lubricant compositions included a first particulate component such as an atomised glyceryl distearate (low melting or softening point, Tₘ₁ ˜56° C.) or a glyceryl behenate (low melting or softening point 69° C.-74° C.) acting as a glue adhering to die walls having a higher surface temperature Tₛ. The solid particulate lubricant compositions further included a second particulate component which is a polyethylene atomised particles adhering to the first particulate component during compaction of the cylinders and helping the sliding thereof out of the die during ejection. The compositions that were used as external lubricant for the DWL system are described in Table 3.

TABLE 3
Solid particulate lubricant compositions

| Material | Lube 1 | Lube 1-1 | Lube 2 | Lube 3 | Lube 4 | Lube 5 |
|---|---|---|---|---|---|---|
| Glyceryl | 50 | 25 | — | — | — | — |
| distearate | | | | | | |
| (%) | | | | | | |
| Glyceryl | — | | 25 | 50 | 10 | 75 |
| behenate (%) | | | | | | |
| Polyethylene | 50 | 75 | 75 | 50 | 90 | 25 |
| (%) | | | | | | |
| Die | 65 | 65 | 85 | 85 | 85 | 85 |
| Temperature | | | | | | |
| (° C.) | | | | | | |

### Calibration

The compressibility and optimum compaction parameters for the metallurgical powder mixture of the previous examples (ATOMET 1001 HP™ with an insulating resin and no internal lubricant) were first identified for a cylindrical shape with a high aspect ratio (length to diameter ratio). An aspect ratio of 1.8 was targeted (L=1.8 cm, D=1 cm). Approximately 10 g of the metallurgical powder mixture was used for each specimen. The parts were initially pressed at the bottom of the die and the ejection was also carried out from the bottom. These operating conditions resulted in a too long sliding distance for the parts which is not representative of what is done in the industry with a double action tooling (lower punch and upper punch action) and therefore, the method was subsequently modified by inserting a spring spacer on the lower punch which allowed to press the parts in the middle of the die and thereby reduce the sliding distance. The lubrication of the die walls was done by manual application of zinc stearate (spray can), referred to as ZnSt spray, and compaction performed at room temperature. The die filling was carried out using a funnel to prevent metallurgical powder friction on the die wall which could potentially remove the lubricant coating. Compaction pressures ranging from 30 to 50 tsi were applied. A green compact density of 7.20 g/cm³ at 50 tsi could be reached in these conditions.

### Results

A superior adherence to the die walls was observed with all the solid particulate lubricant compositions of the table 3 compared to the composite lubricant of the example 3 and a uniform white layer of lubricant could be seen on the die walls after the automated lubrication of die wall when the die was heated to 85° C. All Lubricants of the Table 3 also showed better compaction and lower ejection forces compared to the composite lubricant of the example 3.

FIG. 6 compares the compressibility of the metallurgical powder mixture using the various solid particulate lubricant compositions on the die walls, using the ZnSt spray or using the composite lubricant of the example 3, which was supposed to be the best performing lubricant for the compaction of this metallurgical powder mixture containing no internal lubricant with an automatic system. Due to the difficult ejection with this composite lubricant (example 3), it was only pressed at 30 tsi and the green compact density of the cylinder was significantly lower than with the other lubricants. Using Lube 1 with the die heated to 65° C., the densification curve of the metallurgical powder mixture is slightly better than with the ZnSt spray at room temperature. By using Lube 2 at 85° C., a further improvement in compressibility is obtained compared to the ZnSt spray with a density of 7.33 g/cm³ reached at 50 tsi (versus 7.19 g/cm³ for the ZnSt). The improved compressibility is mainly due to the increased die temperature up to 85° C.; a well-known phenomenon observed in warm compaction. From these results, it is seen that when the lubrication of the die walls is inefficient as with the lubricant of the example 3, it is even difficult to press parts (not only eject them).

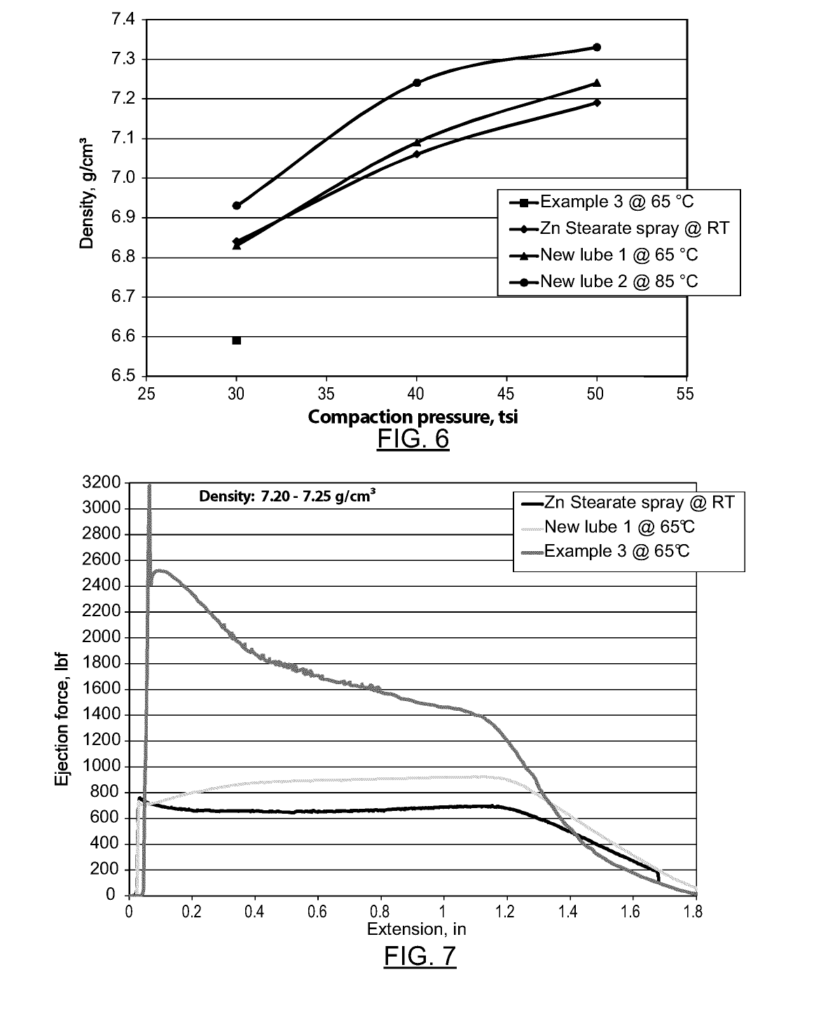

FIG. 7 illustrates the ejection curves of the metallurgical powder mixture in cylinder shape with Lube 1 solid particulate lubricant composition on the die walls, using the ZnSt spray or using the lubricant of the example 3. The peak ejection forces are similar for Lube 1 and ZnSt spray. However, the lubricant of example 3 gives a very high peak force at 3200 lbf (four times higher than with the other lubricants). The sliding ejection forces are similar for the solid particulate lubricant compositions (in the range of 900 to 1100 lbf) and significantly lower than with the lubricant of the example 3 but slightly higher than with the ZnSt spray (<800 lbf). The surface finish was acceptable for certain parts and good for others. There was no visible galling while using the solid particulate lubricant compositions. Ejection forces were found to be little affected by the ratio of the different components. Similar tests showed that Lube 2 was the most efficient in terms of densification with a green compact density of 7.33 g/cm³ reached at 50 tsi (versus 7.20 g/cm³ up to 7.28 g/cm³ for the three other lubricants containing glyceryl behenate).

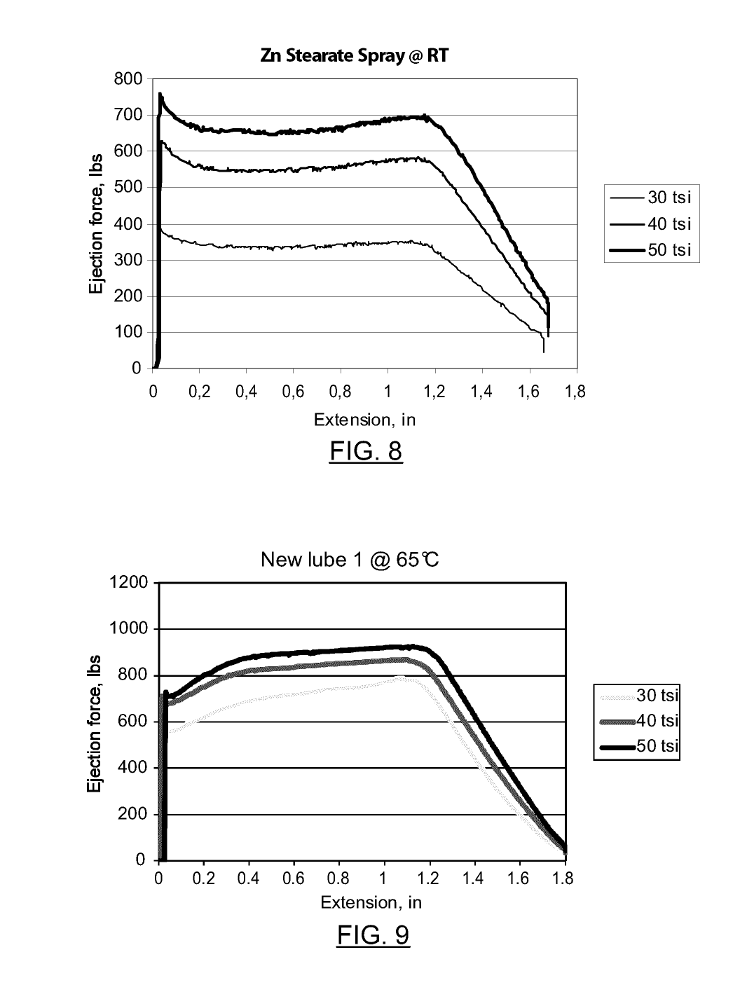

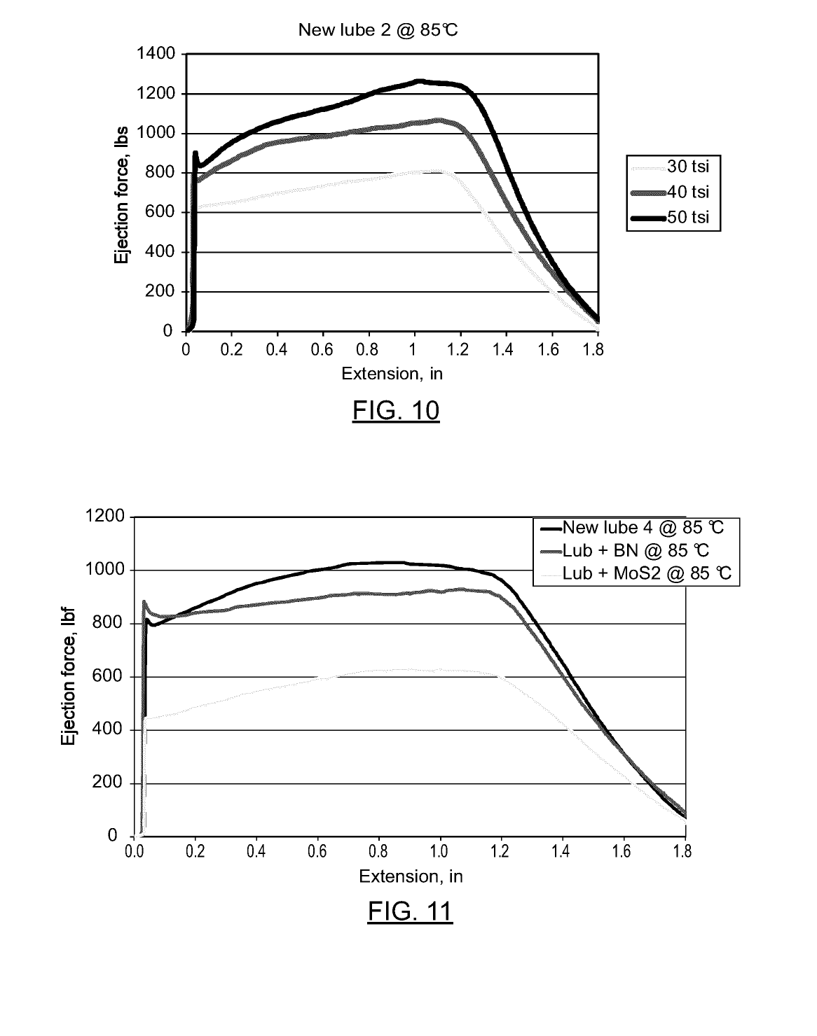

FIGS. 8 to 10 illustrate ejection curves related to the effect of the compaction pressure for the metallurgical powder mixture in term of cylinders pressed using the ZnSt spray at room temperature, Lube 1 at 65° C. and Lube 2 at 85° C. As expected, for all lubricant systems, ejection forces increase with compaction pressure. However, ejection forces with Lube 1 show less sensitivity to the compaction pressure. It was noted that the peak force is higher than the sliding forces when using the ZnSt spray, contrary to the Lube 1 and Lube 2.

### Effect of the Length and Shape of the Confining Block of the DWL System

The effect of confining block length and shape (straight or plain cylinder block and helicoidal block) was also investigated (illustrated in FIG. 5). Few tests were run in order to see if the shape and length of the confining block of the DWL system could influence the quantity and thickness of lubricant coating applied on the die walls. Ejection forces for the cylinders pressed using the helicoidal block were slightly lower than those measured using the plain or straight block. Also, a longer block was better than a short block in terms of lubricant coating consistency and uniformity.

### Example 5 (According to the Present Invention)

Boron nitride (BN) and molybdenum disulfide (MoS2) were tested as lubricant additives to the solid particulate lubricant composition. BN and MoS2 were added to two composite lubricant compositions: 20% BN-30% Polyehtylene-50% Glyceryl Behenate and 20% MoS2-30% Polyehtylene-50% Glyceryl Behenate. BN was found to be very easy to mix with the other lubricant particulate components with no agglomeration. A uniform and consistent coating could be sprayed on the die walls and high density cylinders were obtained with the use of BN: 7.18 and 7.32 g/cm³ at 38.6 and 50 tsi, respectively. Then same metallurgical powder mixture as the previous example was used.

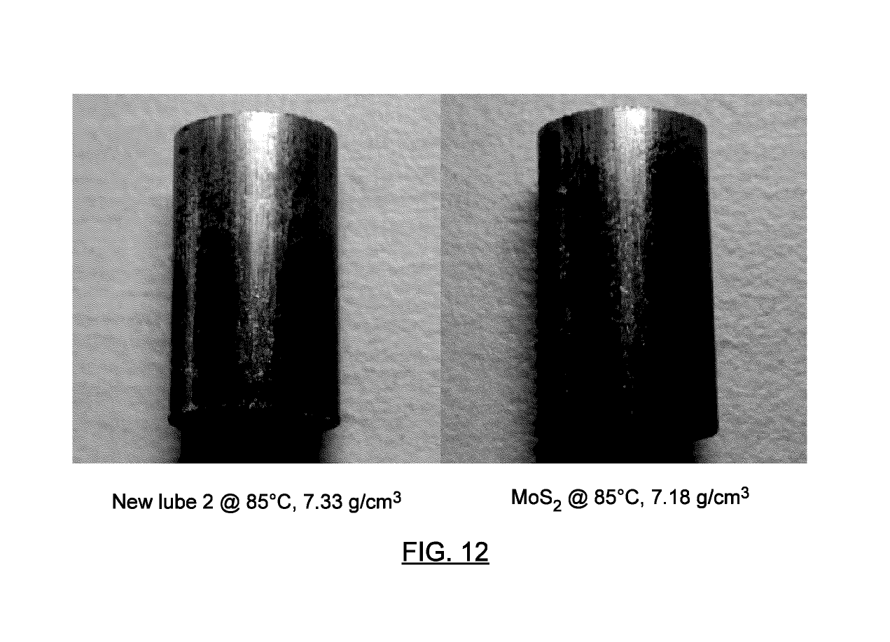

As illustrated in FIG. 11, for cylinders pressed to 7.18 g/cm³, an ejection curve similar to that of Lube 4 (10% glyceryl behenate) was obtained by adding BN. By adding MoS2 instead, the ejection force further decreased significantly. The densification with this latter lubricant system was similar to the previous with a green compact density of 7.18 g/cm³ at 38.6 tsi. A good surface finish was obtained with both BN and MoS2 lubricant additives.

Referring to FIG. 12, a typical surface finish is shown for two cylinders pressed using Lube 2 and the MoS2 added composite lubricant at two different densities. Again there is no galling on the surface but a relatively thick lubricant coating (or residue) can be seen.

### Example 6 (According to the Present Invention)

Another experiment was performed in order to see if the addition of a small quantity of an internal lubricant in the metallurgical powder mixture could improve the compaction/ejection behavior using the DWL system.

It has been found that an addition of 0.1% internal lubricant in the metallurgical powder mixture had some beneficial effects. For example, it increases the apparent density and improves flow. Tests were also conducted with Lube 2 of the table 3, applied using the DWL system. The peak ejection force reached with mix containing 0.1% internal lubricant was 1130 lbf compared to 1262 lbf for the mix without the internal lubricant; representing a 10% reduction in ejection forces.

### Example 7 (According to the Present Invention)

Another experiment was performed to evaluate the efficiency of using a gaseous component as first component of the lubricant composition. Water vapor was used in this experiment.

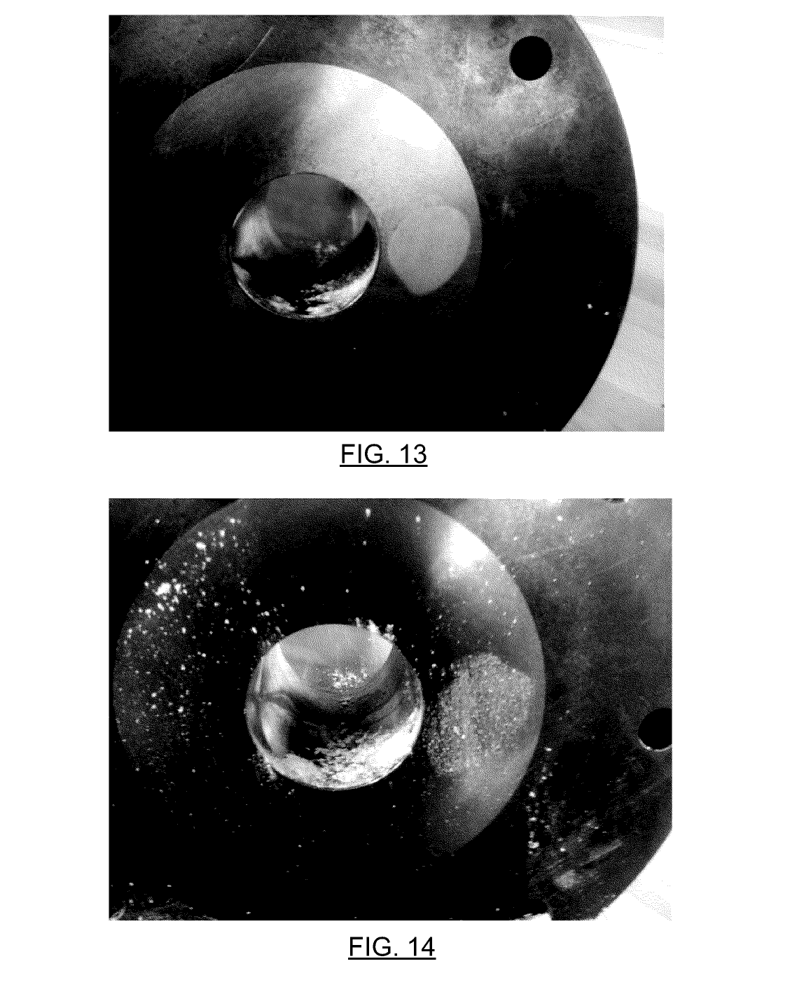

Water was heated at 50° C. and sent to a specific zone of the die with a flow rate of 2 L/min during 1 second, through a pipe having ¼ po I.D. at a distance of ½ po from the entrance of the die surface. Water vapor was therefore applied to this specific zone of the die surface only and condensate while contacting the die wall surface (a round spot of condensed water vapor is seen on a right part of the die on FIG. 13).

A powder of polyethylene is then provided into the entire die surface. FIG. 14 shows the results of the coating. The polyethylene powder has better adhered to the condensed water than other parts of the die surface (seen as a round white spot on FIG. 14).

### Example 8 (According to the Present Invention)

All the previous experimentations were done another time but with a regular feeding system rather than with a funnel to increase abrasion against the die wall during the feeding of the die cavity with the metallurgical powder. For this operation, a plastic block with a hole containing the metallurgical powder was moved on the top of the die, above and across the aperture of the die, for abrupt filling thereof. There was no difference in the results, proving that the adhesion of the lubricant composition is sufficient to sustain normal feeding operation.

### Example 9 (According to the Present Invention)

Transverse Rupture Specimens (TRS) (ASTM B528) or blocks were produced at a very high thickness to produce a similar ratio M/Q than with the cylinders of the previous examples. The dimensions of the TRS blocks were 1.25 inch (31.75 mm) long, 0.5 inch (12.7 mm) wide and 1.1 inch (28 mm) thick, for a weight of 81 grams, giving a M/Q of 6.17. The lubricant was delivered in the cavity with or without the use of a confining block as referred to the U.S. Pat. No. 6,299,690. When no block was used, the lubricant was simply sprayed from three equally distant 3 mm external diameter hoses positioned above the die cavity. The metallurgical powder was poured in the die cavity with a conventional technique similar to a production press feed shoe (a plastic block with a hole moved above the cavity rapidly, at a speed of 20 cm/sec).

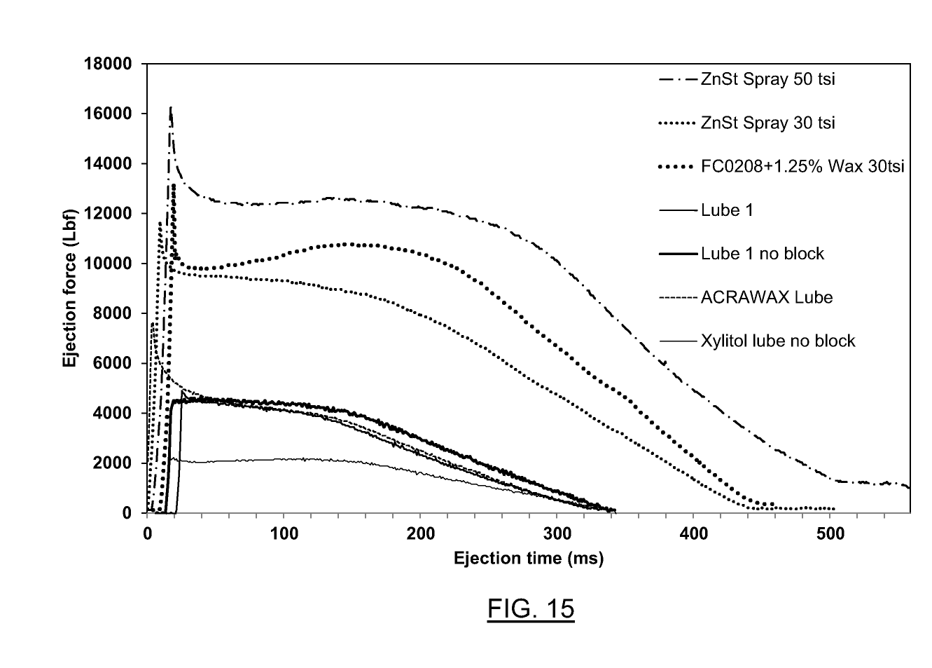

The results of ejection of the different composite lubricants were compared to ZnSt spray. FIG. 15 compares the ejection curves obtained for different tested lubricant compositions including compositions according to the present invention. An ejection curve for a conventional mix (FC0208) containing a very high amount of internal lubricant (1.25% ACRAWAX C Atomised™) and pressed at only 30 tsi (400 MPa) is also reported for a comparison point.

It was not possible to eject parts with an acceptable surface finish because of galling and scoring problems with the conventional mix (FC0208) at a compacting pressure higher than 30 tsi. The compaction with the ZnSt spray was also very difficult. It was possible to obtain acceptable surface finish only at 30 tsi (400 MPa). An ejection curve at 50 Tsi (690 MPa) is nevertheless reported even if the surface finish of the part was very bad and the die was affected. Indeed, the lower end of the ejection curve shows that the pressure, when the compressed part and the punch exit the die, never returns to zero, showing that some material may be stuck between the punch and the die. A major cleaning procedure had to be done after the pressing and ejection of this part.

The die cavity was heated to an operating temperature of 65° C. for the lubricant composition containing 10% of glyceryl distearate as a melting agent and 90% of a polyethylene powder (lube 1), or 90% of ethylene bis-Stearamide (ACRAWAX™ Lube). The die cavity was heated to an operating temperature of 110° C. for the lubricant composition containing 25% of Xylitol, a sugar with a low fusion point (93° C.), and containing the same polyethylene powder as the Lube 1. The temperature of the die cavity was maintained at 25° C. for the ZnSt spray lubricant.

FIG. 15 shows that the lubricant compositions according to the present invention gave much lower ejection forces than ZnSt spray lubricant. It can be seen also that the use of the confining block technique described in the U.S. Pat. No. 6,299,690 is no longer required with that new approach where one of the component of the lubricant melt and stick to the die cavity.

1. A method for manufacturing a green compact in a powder metallurgy operation, comprising:
providing a die cavity having die wall surfaces;
providing a lubricant composition comprising:
a first component having a starting phase, an active phase, a transition temperature at which at least part of the first component changes state from the starting phase to the active phase, an active phase temperature range where the first component is in the active phase and a starting phase temperature range where the first component is in the starting phase; and wherein the first component in the active phase adheres to the die wall surfaces; and
a second component in particulate form having a solid phase temperature range where the second component is in a solid state, wherein the second component in solid state adheres to the active phase of the first component;
maintaining the die cavity to an operating temperature falling within said active phase temperature range of the first component;
feeding the lubricant composition at a feeding temperature falling within said starting phase temperature range of the first component and said solid phase temperature range of the second component into the die cavity thereby causing at least part of the first component to change into the active phase and to form with the second component a lubrication layer coating the die wall surfaces
feeding a metallurgical powder mixture into the die cavity;
compacting the metallurgical powder composition in the die cavity at a compaction pressure sufficient to form the green compact; and
ejecting the green compact from the die cavity.

2. The method of claim 1, wherein the operating temperature falls within said solid phase temperature range of the second component.

3. The method of claim 1 or 2, wherein the metallurgical powder mixture comprises at least about 85 wt % of a metal-based powder.

4. The method of claims 1 to 3, wherein the lubricant composition is provided in an amount sufficient to reduce or prevent galling, scoring or damaging the green compact or the die wall surfaces.

5. The method of any one of claims 1 to 4, wherein the step of feeding the lubricant composition into the die cavity comprises:
injecting the lubricant composition via a plug member inserted into the die cavity.

6. The method of any one of claims 1 to 4, wherein the step of feeding the lubricant composition into the die cavity comprises:
guiding a flow of the lubricant composition in the die cavity so as to be close to the wall surfaces.

7. The method of claim 6, wherein the guiding comprises inserting a bloc into the cavity to define a gap between an external surface of the bloc and the die wall surfaces.

8. The method of any one of claims 1 to 7, wherein the second component has a melting temperature above the operating temperature.

9. The method of claim 8, wherein the second component comprises at least one of metal stearates based particles, ethylene bistearamide based particles, polyolefin-based fatty acids based particles, polyethylene-based fatty acids based particles, polyethylene based particles, soap based particles, molybdenum disulfide based particles, graphite based particles, manganese sulfide based particles, calcium oxide based particles, boron nitride based particles, polytetrafluoroethylene based particles, natural wax based particles and synthetic wax based particles.

10. The method of claim 8 or 9, wherein the second component comprises at least two powder compositions.

11. The method of any one of claims 1 to 10, wherein the second component form a barrier between the metallurgical powder mixture and the die wall surfaces during compacting the metallurgical powder composition in the die cavity.

12. The method of any one of claims 1 to 11, wherein the second component form a barrier between the metallurgical powder mixture and the die wall surfaces during ejecting of the green compact from the die cavity.

13. The method of any one of claims 1 to 12, wherein the lubricant composition comprises at least one lubricant additive.

14. The method of claim 13, wherein the lubricant additive comprises at least one of molybdenum disulfide based particles, graphite based particles, manganese sulfide based particles, calcium oxide based particles, boron nitride based particles, polytetrafluoroethylene based particles, boron nitride based particles, and silica based particles.

15. The method of any one of claims 1 to 14, wherein the first component is a first solid particulate component having a melting temperature below the operating temperature.

16. The method of claim 15, wherein the first solid particulate component is at least about 5 wt % based on a total weight of the lubricant composition.

17. The method of claim 15 or 16, wherein the melting temperature of the first solid particulate component is at least about 5° C. lower than the operating temperature.

18. The method of claim 17, wherein the melting temperature of the first solid particulate component is between about 5° C. and about 40° C. below the operating temperature.

19. The method of any one of claims 15 to 18, wherein the melting temperature of the first solid particulate component is greater than a room temperature.

20. The method of any one of claims 15 to 19, wherein the first solid particulate component comprises at least one of a polymeric material and a sugar based material.

21. The method of claim 20, wherein the polymeric material is at least one of a fatty acid, wax based particles, ethylene bistearamide based particles, glyceryl behenate based particles, glyceryl distearate based particles, polyolefin-based fatty acids based particles, polyethylene-based fatty acids based particles, and soap based particles, and wherein the sugar base material is at least one of natural sugar based particles and synthetic sugar based particles.

22. The method of any one of claims 15 to 21, wherein the operating temperature is between about 20° C. and about 300° C.

23. The method of claim 22, wherein the operating temperature is between about 20° C. and about 120° C.

24. The method of claim 23, wherein the operating temperature is between about 60° C. and about 90° C.

25. The method of any one of claims 15 to 24, further comprising the step of:
pre-mixing the first particulate solid component and the second component to produce the lubricant composition, prior to providing the lubricant composition into the die cavity.

26. The method of any one of claims 1 to 14, wherein the first component is a first gaseous component having a condensation temperature higher than the operating temperature.

27. The method of claim 26, wherein the first gaseous component is at least one of water vapor and oil vapor.

28. The method of claim 26, wherein the oil vapor is a vapor of an oil having a boiling point at least about 40° C. below a burning point or fume point.

29. The method of claim 27 or 28, wherein the oil vapor comprises a vapor of vegetal sourced oil.

30. The method of claim 29, wherein the oil vapor is a vapor of palm oil.

31. The method of any one of claims 27 to 30, wherein the condensation temperature of the first gaseous component is at least about 10° C. higher than the operating temperature.

32. The method of any one of claims 27 to 31, wherein the operating temperature is between about 20° C. and about 200° C.

33. The method of claim 32, wherein the operating temperature is between about 20° C. and about 150° C.

34. The method of any one of claims 1 to 33, wherein the step of providing the lubricant composition into the die cavity comprises:
providing one of the first solid particulate component or second component into the die cavity; and
providing the other of the first solid particulate component or second component into the die cavity.

35. The method of any one of claims 1 to 33, wherein the step of providing the lubricant composition into the die cavity comprises providing simultaneously the first component and the second component into the die cavity.

36. The method of any one of claims 1 to 35, comprising increasing gas flow perturbation in a gap defined between a plug member and the die wall surfaces.

37. The method of claim 36, wherein the increasing of the gas flow perturbation comprises providing at least one of ribs, dimples and other irregularities on an external surface of the plug member such that a mixture of lubricant composition and gas injected into the gap is subjected to the increased gas flow perturbation.

38. The method of claim 36 or 37, wherein the increasing of the gas flow perturbation is sufficient to increase collisions of the lubricant composition against the wall surfaces of the die cavity.

39. The method of claim 38, wherein the increased collisions results in an increased thickness or an increased die coverage density of a lubricant layer on the die wall surfaces.

40. A method for lubricating a die cavity for a powder metallurgy operation, comprising:
providing a lubricant composition into the die cavity, the lubricant composition comprising:
a first component having a starting phase, an active phase, a transition temperature at which at least part of the first component changes state from the starting phase to the active phase, an active phase temperature range where the first component is in the active phase and a starting phase temperature range where the first component is in the starting phase; and wherein the first component in the active phase adheres to the die wall surfaces; and
a second component in particulate form having a solid phase temperature range where the second component is in a solid state, wherein the second component in solid state adheres to the active phase of the first component;
maintaining the die cavity to an operating temperature falling within said active phase temperature range of the first component;
feeding the lubricant composition at a feeding temperature falling within said starting phase temperature range of the first component and said solid phase temperature range of the second component into the die cavity thereby causing at least part of the first component to change into the active phase and to form with the second component a lubrication layer coating the die wall surfaces.

41. The method of claim 40, wherein the operating temperature falls within the solid phase temperature range of the second component.

42. A method for manufacturing a green compact in a powder metallurgy operation, comprising:
heating a die cavity having die wall surfaces to an operating temperature;
providing a solid particulate lubricant composition into the die cavity, the solid particulate lubricant composition comprising:
a first particulate component having a melting temperature lower than the operating temperature of the die such that at least part of the first particulate component melts in contact with the die wall surfaces to form a melted component; and
a second particulate component having a sufficiently high melting temperature to remain in solid state at the operating temperature, thereby allowing at least part of the second particulate component to adhere to the melted component;
wherein the melted component and the second particulate component form a lubrication layer coating the die wall surfaces;
feeding a metallurgical powder mixture into the die cavity;
compacting the metallurgical powder composition in the die cavity at a compaction pressure sufficient to form the green compact; and
ejecting the green compact from the die cavity.

43. The method of claim 42, further comprising:
charging the solid particulate lubricant composition, prior to providing the solid particulate lubricant composition into the die cavity, such that the solid particulate lubricant composition is electrostatically attracted to the die wall surfaces.

44. The method of claim 42 or 43, further comprising:
triboelectrically charging the solid particulate lubricant composition, prior to providing the solid particulate lubricant composition into the die cavity, such that the solid particulate lubricant composition is electrostatically attracted to the wall surfaces of the die cavity.

45. A method for manufacturing a green compact in a powder metallurgy operation, comprising:
maintaining a die cavity having die wall surfaces to an operating temperature;
providing a lubricant composition into the die cavity, the lubricant composition comprising:
a first gaseous component having a condensation temperature higher than said operating temperature of the die such that at least part of the first gaseous component condensate in contact with the die wall surfaces to form a liquid component; and
a second particulate component having a sufficiently high melting temperature to remain in solid state at the operating temperature, thereby allowing at least part of the second particulate component to adhere to the liquid component;
wherein the liquid component and the second particulate component form a lubrication layer coating the die wall surfaces;
feeding a metallurgical powder mixture into the die cavity;
compacting the metallurgical powder composition in the die cavity at a compaction pressure sufficient to form the green compact; and
ejecting the green compact from the die cavity.

46. A method for lubricating a die cavity for a powder metallurgy operation, comprising:
heating the die cavity having die wall surfaces to an operating temperature;
providing a solid particulate lubricant composition into the die cavity, the solid particulate lubricant composition comprising:
a first particulate component having a melting temperature lower than said operating temperature of the die cavity such that at least part of the first particulate component melts in contact with the die wall surfaces to form a melted component;
a second particulate component having a sufficiently high melting temperature to remain in solid state at said operating temperature, thereby allowing at least part of the second particulate component to adhere to the melted component;
wherein the melted component and the second particulate component form a lubrication layer coating the die wall surfaces.

47. A method for lubricating a die cavity for a powder metallurgy operation, comprising:
maintaining the die cavity having die wall surfaces to an operating temperature;
providing a lubricant composition into the die cavity, the lubricant composition comprising:
a first gaseous component having a condensation temperature higher than said operating temperature of the die such that at least part of the first gaseous component condensate in contact with the die wall surfaces to form a liquid component; and
a second particulate component having a sufficiently high melting temperature to remain in solid state at the operating temperature, thereby allowing at least part of the second particulate component to adhere to the liquid component;
wherein the liquid component and the second particulate component form a lubrication layer coating the die wall surfaces.

48. A lubricant composition for lubricating die wall surfaces of a die cavity, the lubricant composition comprising:
a first component in a starting phase, the first component having:
an active phase wherein the first component is adapted to adhere to the die wall surfaces;
said starting phase; and
an active phase temperature range adapted for transition of the first component from the starting phase to an active phase in contact with the die wall surfaces;
a second component in solid state and having a solid state temperature range allowing the second component to adhere to the active phase of the first component.

49. The lubricant composition of claim 48, wherein the first component is a first solid particulate component having a melting temperature adapted for transition from the starting phase to the active phase in contact with the wall surfaces.

50. The lubricant composition of claim 48 or 49, wherein the first solid particulate component is at least about 5 wt % based on a total weight of the lubricant composition.

51. The lubricant composition of any one of claims 48 to 50, wherein the first solid particulate component comprises at least one of a polymeric material and a sugar based material.

52. The lubricant composition of claim 51, wherein the polymeric material is at least one of a fatty acid, ethylene bistearamide based particles, polyolefin-based fatty acids based particles, polyethylene-based fatty acids based particles, and soap based particles, and wherein the sugar based material is at least one of natural sugar based particles or synthetic sugar based particles.

53. The lubricant composition of claim 48, wherein the first component is a first gaseous component having a condensation temperature adapted for transition from the starting phase to the active phase in contact with the wall surfaces.

54. The lubricant composition of claim 53, wherein the first gaseous component is at least one of water vapor or oil vapor.

55. The lubricant composition of claim 54, wherein the oil vapor is a vapor of an oil having a boiling point at least about 40° C. below a fume point or burning point.

56. The lubricant composition of claim 53 or 54, wherein the oil vapor comprises a vapor of vegetal sourced oil.

57. The lubricant composition of claim 56, wherein the oil vapor is a vapor of palm oil.

58. A solid particulate lubricant composition for lubricating wall surfaces of a die cavity, the solid particulate lubricant composition comprising:
a first component having a melting temperature which is adapted to form a melted component in contact with the wall surfaces through melting of at least part of the first particulate component; and
a second particulate component having a melting temperature allowing the second particulate component to remain in solid state in contact with the wall surfaces and thereby allowing at least part of the second particulate component to adhere to the melted component.

59. An apparatus for lubricating die wall surfaces for a powder metallurgy operation, comprising:
a lubricant delivery system for delivering a lubricant composition;
a die comprising:
a die cavity defined by wall surfaces;
an inlet in fluid communication with the lubricant delivery system for receiving the lubricant composition into the die cavity for deposition onto the wall surfaces; and
a temperature management system coupled to the lubricant delivery system and the die for controlling at least one of an operating temperature of the lubricant delivery system and an operating temperature of the die.

60. The apparatus of claim 60, wherein the temperature management system is configured for controlling the operating temperature of the lubricant delivery system below the operating temperature of the die.

61. The apparatus of claim 60, wherein the temperature management system is configured for controlling the operating temperature of the lubricant delivery system above the operating temperature of the die.

62. The apparatus of any one of claims 60 to 62, comprising a charging system coupled to the solid lubricant delivery system for electrically charging the solid particulate lubricant composition.

63. The apparatus of claim 63, wherein the charging system is a triboelectrical charging system.
